(19) United States
(12) Patent Application Publication
(10) Pub. No.: US 2013/0028684 A1
(43) Pub. Date: Jan. 31, 2013

(54) STRUCTURE FOR PREVENTING INCORRECT ADVANCE OF SCREWS

(71) Applicant: PANASONIC CORPORATION, Osaka (JP)

(72) Inventor: Takayuki OHSUGI, Hokkaido (JP)

(73) Assignee: PANASONIC CORPORATION, Osaka (JP)

(21) Appl. No.: 13/632,495

(22) Filed: Oct. 1, 2012

Related U.S. Application Data
(63) Continuation-in-part of application No. PCT/JP2011/001647, filed on Mar. 18, 2011.

(30) Foreign Application Priority Data
Apr. 8, 2010 (JP) 2010-089102

(51) Int. Cl. F16B 41/00

(52) U.S. Cl. 411/511

(57) ABSTRACT

A structure for preventing an incorrect advance of screws capable of reliably preventing incorrect screw advance with a simple configuration is provided. The incorrect screw advance preventing structure of the present disclosure includes: a first member having a screw hole in which a screw thread corresponding to the screw is formed; and a second member having an opening provided in a position opposed to the screw hole, and a slope part that rises from a peripheral edge of the opening toward the first member. In this structure, a tip of a long screw which is inadvertently inserted is guided in a predetermined direction by the slope part. Therefore, it is possible to prevent the tip of the screw from reaching an area to be protected, or let the tip of the screw move away from the area to be protected.

### CROSS REFERENCE TO RELATED APPLICATION

This application is a continuation-in-part application of international patent application No. PCT/JP2011/001647, filed Mar. 18, 2011, which claims priority to Japanese Patent Application No. 2010-089102, filed on Apr. 8, 2010. The foregoing applications are incorporated herein by reference.

### BACKGROUND

1. Field

The present disclosure relates to a structure for preventing an incorrect advance of screws. More specifically, the present disclosure relates to a structure, provided on a housing of electronic equipment, for preventing a tip of a screw from advancing toward a component that should be protected when an incorrect screw longer than the normal length is inserted.

2. Description of the Related Art

Japanese Laid-Open Patent Publication No. 11-294436 (this publication is called “Yamaguchi” hereafter) discloses a structure which prevents an incorrect insertion of a screw. In Yamaguchi, when an incorrect screw (component 4 in FIG. 1 of Yamaguchi) is screwed, the insertion of the screw is prevented when a tip of the screw reaches a blind hole (component 8). As a result, the screw inserting portion (component 53) is forced to rotate in a plane perpendicular to the insertion direction. However, this rotation is intercepted by a rotation intercepting component (component 54). As a result, advance of the screw can be stopped.

### SUMMARY

The present disclosure provides a structure for preventing an incorrect advance of screws which can reliably prevent an incorrect screw advance, with a simple configuration.

The structure of the present disclosure includes: a first member having a screw hole in which a screw thread corresponding to the screw is formed; and a second member having an opening provided in a position opposed to the screw hole, and a slope part that rises from a peripheral edge of the opening toward the first member.

According the structure of the present disclosure, it can reliably prevent incorrect advance of screws with a simple configuration.

### BRIEF DESCRIPTION OF THE DRAWINGS

FIG. 1A is a top view of a structure for preventing an incorrect advance of screws according to an embodiment of the present disclosure;

FIG. 1B is a front view of the above structure;

FIG. 1C is a bottom view of the above structure;

FIG. 1D is a left side view of the above structure;

FIG. 2A is a partial enlarged view of FIG. 1A;

FIG. 2B is a cross-sectional view taken along a line A-A′ in FIG. 2A;

FIG. 3 is a perspective rear view of a plasma display 11 having the structure 1 for preventing an incorrect advance of screws shown in FIG. 1;

FIG. 4 is an enlarged view of the plasma display 11, in which a dashed rectangle shown in FIG. 3 is enlarged;

FIG. 5 is a rear view of the plasma display 11 with a back cover being removed;

FIG. 6 is a perspective view of a part of the plasma display 11 with a back cover being removed;

FIGS. 7A and 7B are side views illustrating a state where an incorrect screw is inserted in an instant structure;

FIG. 8 is a side view illustrating a state where an incorrect screw is inserted in a modified structure; and

FIG. 9 is a side view illustrating a state where a screw is inserted in another modified structure.

### DETAILED DESCRIPTION

Hereinafter, embodiments will be described in detail with reference to the drawings. It should be noted that a detailed description more than a necessity may be omitted. For example, a detailed description of well-known matters or an overlapping description of substantially same configurations may be omitted. This is to avoid an unnecessarily redundant description below and to facilitate understanding of a person skilled in the art.

It should be noted that the inventors provide the accompanying drawings and the following description so that a person skilled in art can fully understand the present disclosure, and this is not intended for limiting the definition of the subject matter defined by the claims.

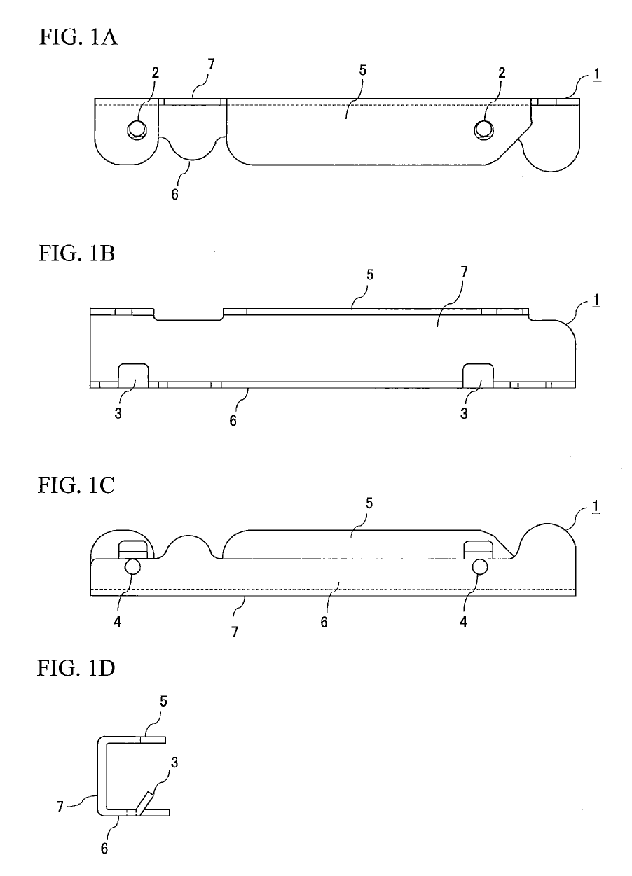

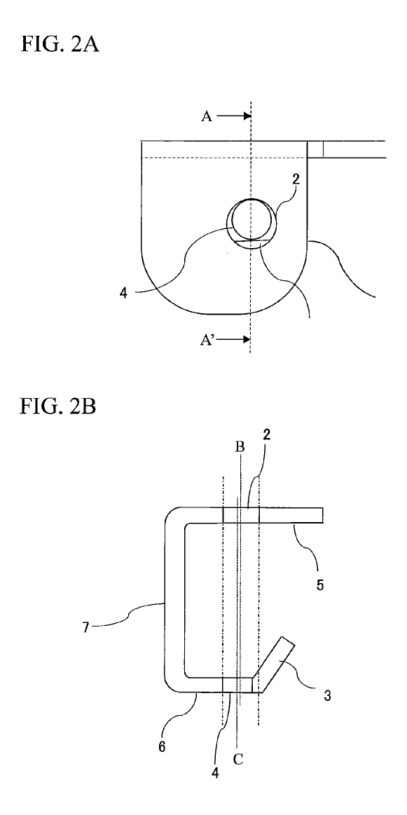

FIGS. 1A to 1D illustrate a structure for preventing an incorrect advance of screws according to an instant example (this structure is referred to as “preventing structure 1” hereafter). FIGS. 2A and 2B are enlarged views of major parts of the structure shown in FIG. 1. Specifically, FIG. 1A is a top view, FIG. 1B is a front view, FIG. 1C is a bottom view, and FIG. 1D is a left side view. Further, FIG. 2A is a partial enlarged view of FIG. 1A, and FIG. 2B is a cross-sectional view taken along a line A-A′ shown in FIG. 2A.

The preventing structure 1 is a member for receiving a screw for fastening another member. When an incorrect screw having a length longer than a designed value is inserted, the structure 1 prevents the tip of the screw from advancing toward a component to which this screw should not be contacted. The preventing structure 1 includes an upper plate part 5, a lower plate part 6 facing the upper plate part 5, and a vertical plate part 7 connecting the upper plate part 5 and the lower plate part 6. In the instant example, the upper plate part 5, the lower plate part 6, and the vertical plate part 7 are integrally formed of a single metal plate by bending the metal plate.

Referring to FIG. 1A, screw holes 2 into which screws are to be screwed are formed in the upper plate part 5. Referring to FIG. 1C, openings 4 are formed in the lower plate part 6 at positions opposing the screw holes 2 (see FIG. 1A also). In the instant example, each of the openings 4 is a circular hole, and no screw thread is formed on the inner periphery of the opening 4. Referring to FIG. 1D, a sloping guide part 3 is formed by bending, toward the upper plate part 5, a portion of the lower plate part 6 near its outer edge. The sloping guide part 3 has a slope which rises from a peripheral edge of the opening 4 toward the upper plate part 5 (see FIG. 2B also), and approaches the upper plate part 5 as the distance from the opening 4 increases.

Hereinafter, the dimensions of the screw hole 2, the opening 4, and the sloping guide part 3, and the positional relationship between them will be described in detail.

In the instant example, the inner diameter of the opening 4 is designed smaller than the inner diameter of the screw hole 2, and larger than the outer diameter of a tip of a screw having a screw thread conforming to the screw hole 2. The center of the opening 4 does not coincide with the center of the screw hole 2, and is deviated toward the vertical plate part 7. Accordingly, the center axis B passing through the center of the screw hole 2 (which substantially coincides with the center axis of the screw having the screw thread conforming to the screw hole 2) does not coincide with the center axis C passing through the center of the opening 4.

Since the inner diameter of the opening 4 is smaller than the inner diameter of the screw hole 2, and the center of the opening 4 deviates from the center of the screw hole 2 to the vertical plate part 7 side, the opening 4 side of the sloping guide part 3 comes beneath the screw hole 2 as shown in FIG. 2A and FIG. 2B.

For simplicity, holes other than the screw holes 2 and the openings 4 are not shown in FIG. 1. However, holes for attaching the preventing structure 1 to a housing of electronic equipment may be formed in the lower plate part 6, for example.

[Utilization of the Structure 1]

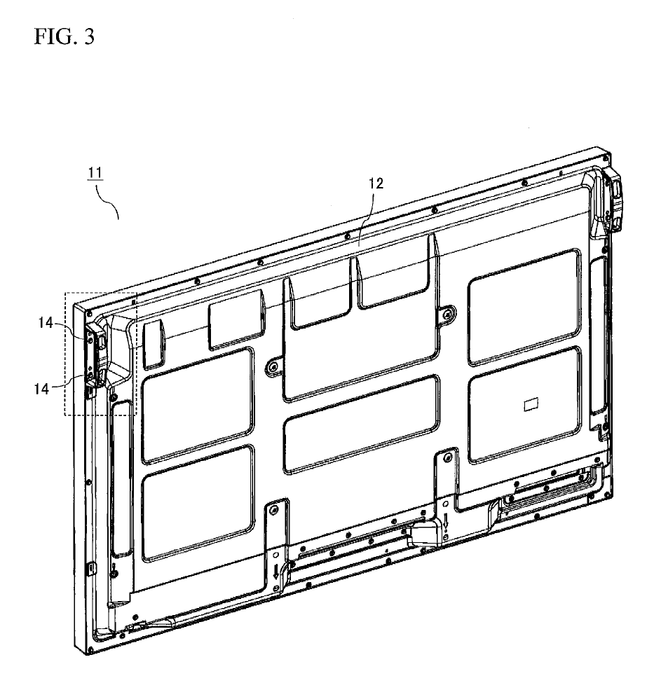

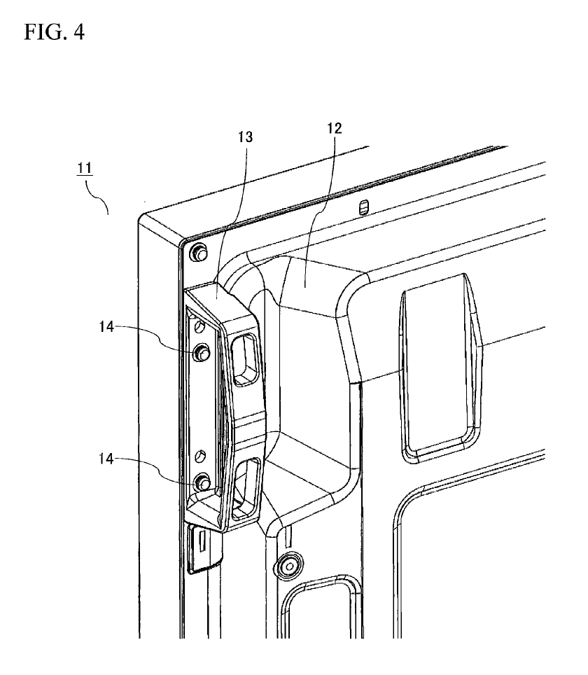

FIG. 3 is a rear perspective view of a plasma display 11 having the preventing structure 1 shown in FIG. 1. This figure shows the view of the plasma display 11 when a back cover is removed. FIG. 4 is an enlarged view of a dashed rectangle portion shown in FIG. 3.

A plasma display 11 has a display section for displaying an image. A back cover 12 covers the entirety of the back surface of the plasma display 11. The back cover 12 is screwed to the housing. A pair of handles 13 provided near the upper corners of the back surface of the plasma display 11 is for carrying the plasma display 11. The handles 13 are screwed together with the back cover 12 onto the housing of the plasma display 11 by screws 14.

As shown in FIG. 4, a pair of screw holes are formed in the handle 13 at the position which contacts the outer surface of the back cover 12. Likewise, each of the back cover 12 and the housing of the plasma display 11 have screw holes formed near their end edge. By using these screw holes, the housing of the plasma display 11, the back cover 12, and the handle 13 are screwed together with the screws 14. Each of the screw holes in the housing of the plasma display 11 for attaching the handle 13 is equivalent to the screw hole 2 of the preventing structure 1 described above. Hereinafter, this is described in detail.

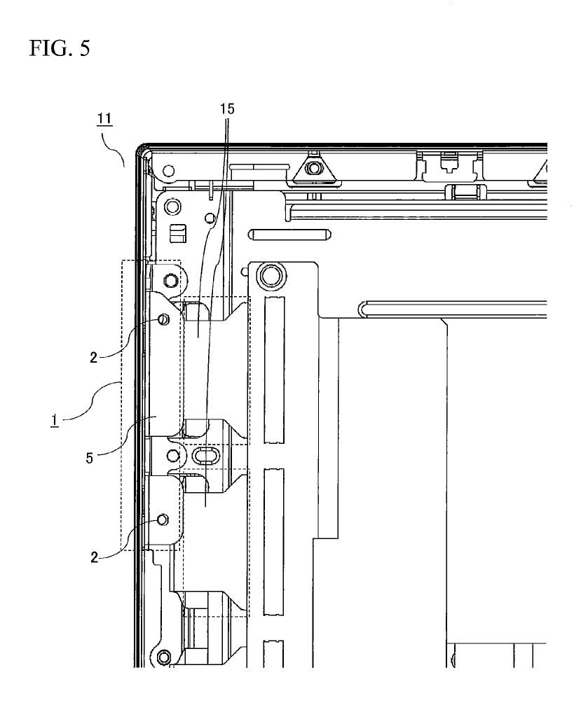

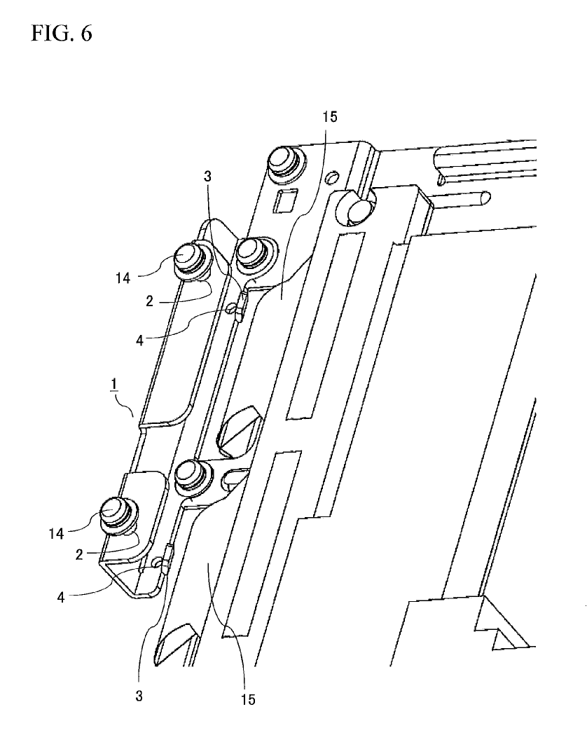

FIG. 5 shows a rear view of the plasma display 11. FIG. 6 is a perspective view and an enlarged view of FIG. 5. FIG. 6 differs from FIG. 5 that it shows screws 14 screwed in each of the screw holes 2.

The preventing structure 1 is arranged so that the lower plate part 6 is positioned at the display section side of the plasma display 11, and upper plate part 5 is positioned behind the lower plate part 6. As shown in FIG. 6, the preventing structure 1 is fixed by screwing the lower plate part 6 to the housing. When the back cover 12 is attached, the outer surface of the upper plate part 5 contacts the inner surface of the peripheral edge of the back cover 12.

A plurality of wide flexible cables 15 are arranged on the peripheral edge of the plasma display 11. The flexible cables 15 are used for transmission of video signals in the plasma display 11, specifically a transmission between a plasma panel and a plasma panel controlling circuit provided on the rear edge side of the plasma panel. The flexible cable 15 has flexibility, but might be shorted or damaged when a sharp object such as the tip of the screw 14 contacts this cable. In the vicinity of the flexible cables 15, the screw holes 2 are arranged, for screwing the screws 14 after covering the housing with the back cover 12. The screws 14 shown in FIG. 6 are normal-length screws (correct screws) for attaching the handle 13 to the housing. Accordingly, even when each screw 14 is completely tightened (screwed), the tip of the screw 14 does not reaches the flexible cables 15, the sloping guide part 3 nor the opening 4.

However, at the time of attaching the handle 13, if an incorrect screw longer than the design length is inadvertently inserted into the screw hole 2 and the advance direction of the incorrect screw deviates toward the inner side of the plasma display 11, the tip of the incorrect screw might contact with the flexible cables 15. In order to prevent such contact between the incorrect screw and the flexible cables 15, the preventing structure 1 is utilized.

Specifically, the preventing structure 1 is arranged such that the sloping guide part 3 is positioned on the side where an area that should be protected exists, so that a component inside this area is protected from being damaged by an inadvertent insertion of a long screw (hereinafter such area is referred to as “protection area”) is present. That is, the preventing structure 1 is attached to the housing so that the opening 4 and the protection area are arranged on the opposite side of the sloping guide part 3 between them. Further, considering the possibility that the incorrect screw might penetrate the opening 4 when a very large torque is applied, the protection area may be arranged in a space on the outer side of the lower plate part 6 (the space on the side opposite to the upper plate part 5) and at least not at a position opposing the opening 4.

[Incorrect Screw Advance Preventing Function]

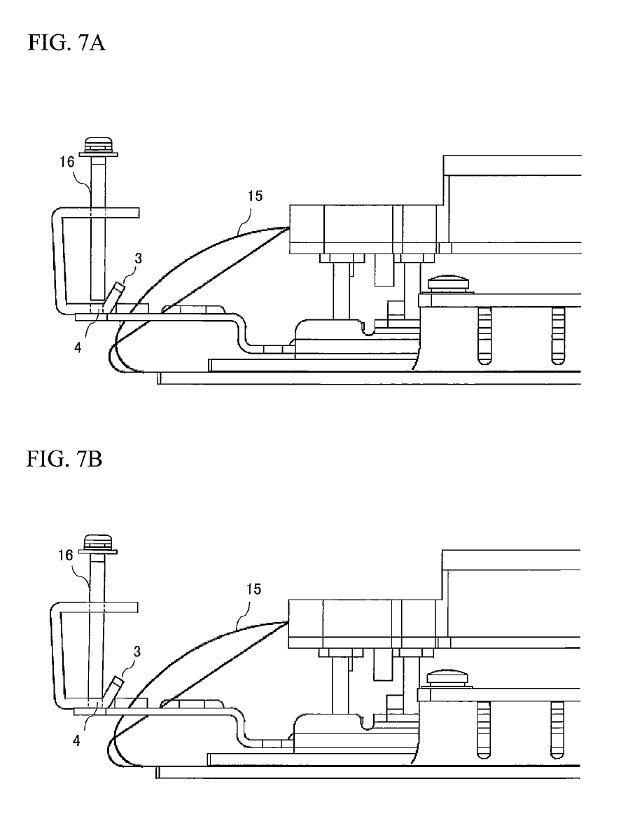

FIGS. 7A and 7B are side views illustrating the state where the incorrect screw is inserted in the preventing structure 1. Specifically, FIG. 7A shows the state where the tip of the incorrect screw 16 is contacted with the sloping guide part 3, and FIG. 7B shows the state where the tip of the incorrect screw 16 is inserted in the opening 4.

The incorrect screw 16 is a screw whose nominal diameter (outer diameter) and screw pitch are equal to those of the screw 14 that is a normal screw, but the nominal length (length of the screw excluding the screw head) is considerably longer than that of the screw 14. For example, when the normal screw 14 has a nominal diameter of 4 mm, a screw pitch of 0.7 mm, and a nominal length of 12 mm, the nominal length of the incorrect screw 16 is 40 mm or longer. In the international standard for safety of products, it is obligated that, when a screw having a length ten times longer than its nominal diameter is inadvertently inserted, this screw should be apart by at least a predetermined distance from an internal dangerous area (area that might cause ignition and/or smoking when damaged, such as a current-carrying portion). Thereby, in the instant example, the nominal length defined in the international standard is assumed as an exemplary length of the incorrect screw.

When the incorrect screw 16 having the nominal length considerably longer than the normal length is inserted in the screw hole 2, first, the tip of the incorrect screw 16 contacts with the sloping guide part 3 as shown in FIG. 7A. This is because the sloping guide part 3 is arranged under the screw hole 2 as shown in FIG. 2B for example.

When the incorrect screw 16 is further screwed from the state where its tip is in contact with the sloping guide part 3, the tip of the incorrect screw 16 is guided leftward along the slope of the sloping guide part 3 to the opening 4 as shown in FIG. 7A. As described above, the opening 4 is a through-hole having no screw thread formed therein, and is designed so that its inner diameter is smaller than the nominal diameter of the incorrect screw 16, and is larger than the outer diameter of the tip of the incorrect screw 16. Therefore, as shown in FIG. 7B, the tip of the incorrect screw 16 fits into the opening 4, and thereby unfavorable advance of the incorrect screw 16 is stopped. As a result, the incorrect screw 16 is prevented from contacting the flexible cables 15. The inner diameter of the opening 4 may be smaller than the nominal diameter of the incorrect screw 16, and the outer diameter of the tip of the incorrect screw 16. Thereby, when a torque which is not very large is applied to the incorrect screw 16, the incorrect screw 16 keeps spinning and will not be inserted in the opening 4. Therefore, a person can notify that this screw is an incorrect screw. On the other hand, when an excessive torque is applied, the incorrect screw 16 fits into the opening 4, and thereby unfavorable advance of the incorrect screw 16 is stopped.

Further, since the tip of the incorrect screw 16 shifts leftward as shown in FIG. 7A guided by the sloping guide part 3, the tip of the incorrect screw 16 fits into the opening 4 with its center axis of the incorrect screw 16 being tilted. This has following advantages. First, since the sloping guide part 3 exists, the incorrect screw 16 that is contacted with the sloping guide part 3 is guided to the opening 4. That is, by existence of the sloping guide part 3, the incorrect screw 16 is prevented from advancing toward the flexible cables 15. Further, in the instant example, since the center of the opening 4 does not coincide with the center of the screw hole 2 and a portion of the sloping guide part 3 is located directly beneath the screw hole 2, the tip of the incorrect screw 16 irresistibly contact with the sloping guide part 3. Further, when the tip of the screw 16 is inserted to the opening 4, the incorrect screw 16 is tilted. Therefore, even when a force in the screw insertion direction is applied to the incorrect screw 16 which is fitted to the opening 4, not all of the force is applied in the vertical direction. That is, since the incorrect screw 16 is tilted, some of the insertion torque applied in the vertically downward direction is converted into horizontal direction components. As a result, it is possible to prevent the preventing structure 1 from being applied an excessive load. Further, even when an excessive torque is applied to the incorrect screw 16 in the state shown in FIG. 7B, it is possible to prevent the incorrect screw 16 from being contacted with the flexible cables 15. That is, if an excessive torque is applied, the incorrect screw 16 may cut off the inner surface of the opening 4 and penetrates the opening 4, however, since the advancing direction of the tip of the incorrect screw 16 turns to the side opposite to the flexible cables 15 (turns leftward in FIG. 7B), the advancing direction of the incorrect screw 16 can be limited to a direction that the incorrect screw 16 does not contact with the flexible cables 15.

The insertion direction of the incorrect screw 16 may be limited by the angle of the center axis of the screw hole 2.

In the above example, the center axis of the opening 4 is deviated to the side opposite to the sloping guide part 3 with respect to the center axis of the screw hole 2, however, the center axis of the screw hole 2 and the center axis of the opening 4 may be coaxial with each other.

Further, the dimension of the opening 4 is not limited to the above-described dimension. The dimension of the opening 4 may be determined by performing an appropriate insertion experiment in accordance with the hardness of material, tightening torque, nominal diameter, and nominal length of a possible incorrect screw 16, or the hardness of material of the sloping guide part 3.

The geometry of the opening 4 is not limited to a circle, as long as the tip of the incorrect screw 16 does not contact the flexible cables 15. For the purpose of fitting the tip of the incorrect screw 16 to the opening 4, the opening 4 may be a polygon such as hexagon or octagon, for example. However, if the opening 4 is circular, it is desirable because the pressing force is dispersed to the whole periphery of the opening 4 when the tip of the incorrect screw 16 fits into the opening 4.

Instead of the opening 4, a recess that is not a through-hole may be formed. Alternatively, a screw thread may be formed in the opening 4. However, a through-hole having no screw thread is favorable in a sense that the processing is facilitated.

[Modifications]

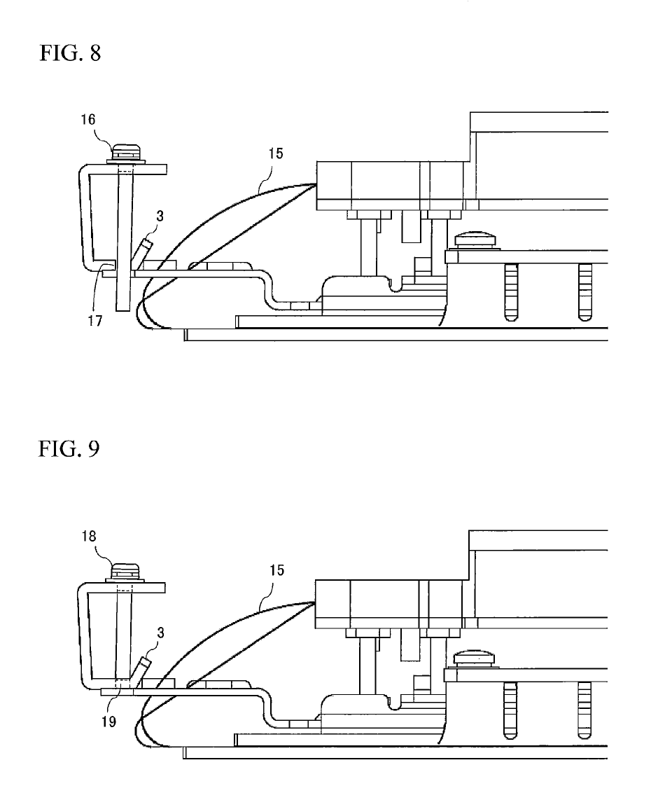

FIG. 8 is a side view of a modified structure for preventing an incorrect advance of screws.

In the structure shown in FIG. 8, an opening 17 having an inner diameter larger than the inner diameter of the screw hole 2 is formed in the lower plate part 6. In this structure, the tip of the incorrect screw 16 is guided to the opening 17 by the sloping guide part 3, and then penetrates the opening 17. Such a structure can be applied when a component which should be protected (such as flexible cables 15 or the like) is not present in the space beneath the opening 17 and therefore the incorrect screw 16 does not contact the protecting component even when it penetrates the opening 17. Or, it can be applied when the incorrect screw 16 is not likely to be come close to the protecting component even when it penetrates the opening 17.

FIG. 9 is a side view illustrating a state where a screw is inserted in another modified structure for preventing an incorrect advance of screws.

In the structure shown in FIG. 9, when a screw 18 is screwed into the screw hole 2, at least a tip of the screw 18 is entering an opening 19. This structure is achieved by adjusting the interval between the upper plate part 5 and the lower plate part 6, and the length of the screw 18. A screw thread may be formed on an inner periphery of the opening 19, and the tip of the screw 18 may be screwed into the opening 19. Alternatively, the tip of the screw 18 may be just brought into contact with the inner periphery of the opening 19. In the structure shown in FIG. 9, the screw 18 bridges the upper plate part 5 and the lower plate part 6 to reinforce the screw receiving member comprising the upper plate part 5, the lower plate part 6, and a vertical plate part 7. As a result, the rigidity of the screw receiving member is increased, thereby improving the resistance to thermal deformation or the like.

In the above-described example, the upper plate part 5, the lower plate part 6, and the vertical plate part 7 are integrally formed by same member. However, these parts may be formed by different members. Alternatively, some or all of the upper plate part 5, the lower plate part 6, and the vertical plate part 7 may be formed integrally with the housing. However, the above described preventing structure is favorable when the upper plate part 5, the lower plate part 6, and the vertical plate part 7 are integrally formed by the same member. The reason is as follows. In such integrated configuration, the strength is not strong enough because an excessive torque may be applied by the incorrect screw 1 to the lower plate part 6, with a contact point between the upper plate part 5 and the incorrect screw 16 being a fulcrum point 6. On the other hand, in terms of cost, it is advantageous to integrally form the upper plate part 5, the lower plate part 6, and the vertical plate part 7 by the same member. In the instant preventing structure, unfavorable advance of the incorrect screw 16 is prevented by the sloping guide part 3 and the opening 4, or by the guide part 3 and the opening 17, even when an excessive torque is applied to the incorrect screw 16. Accordingly, the structure of this modified example is suitable for such integrated plates, and is beneficial in terms of cost.

In the above-described example, the slope of the sloping guide part 3 is plane. Instead, this may be curved. Further, two or more sloping guide parts 3 may be provided.

The preventing structure of the above disclosure is applicable to electronic equipment such as a plasma display.

The above examples have been described above as illustrative examples of the technology in the present disclosure. For that, the accompanying drawings and the detailed description have been provided.

Therefore, the constituent elements described in the accompanying drawings and the detailed description may include not only constituent elements essential for solving the problems but also constituent elements non-essential for solving the problems, in order to illustrate the technology described above. Thus, these non-essential constituent elements should not be readily recognized as being essential, due to these non-essential constituent elements being described in the accompanying drawings and the detailed description.

Furthermore, since the embodiments described above are intended to illustrate the technology in the present disclosure, various changes, substitutions, additions, omissions, and the like can be made within the scope of the claims and the scope of equivalents thereof.

What is claimed is:

1. A structure for preventing advance of a screw, comprising:
a first member having a screw hole in which a screw thread is formed; and
a second member having an opening facing the screw hole, and a slope part that approaches toward the first member as the distance of the opening increases.

2. The structure according to claim 1, wherein the structure prevents an incorrect advance of a screw, or an advance of an incorrect screw.

3. The structure according to claim 1, wherein the opening has an inner diameter that is smaller than an inner diameter of the screw hole, and larger than an outer diameter of a tip of the screw.

4. The structure according to claim 3, wherein
the center of the screw hole does not coincide with the center of the opening, and
a portion of the slope part, which abuts the opening, is located directly beneath the screw hole.

5. The structure according to claim 4, wherein a screw thread is not formed in the opening.

6. The structure according to claim 5, further comprising:
a connection member which connects the first member and the second member, wherein
the first member, the second member, and the connection member are integrally formed of a metal plate.

7. The structure according to claim 1, wherein the inner diameter of the opening is larger than the inner diameter of the screw hole.

8. The structure according to claim 1, which is configured to, when an incorrect screw longer than a screw having a normal length is inserted in the screw hole, prevent a tip of the incorrect screw from advancing toward a protection target area to be protected from contact with the incorrect screw, wherein
the second member is arranged such that the protection target area is positioned in a space opposite to the opening across the slope part, and is not positioned in a space opposite to the first member.
